(19) United States
(12) Patent Application Publication
(10) Pub. No.: US 2010/0276955 A1
(43) Pub. Date: Nov. 4, 2010

(54) TREATMENT OF RAILWAY WHEELS

(75) Inventors: Bernard Chen, Queensland (AU); Timothy Robert Constable, Queensland (AU); Hung Nien Kha, Canberra (AU)

Correspondence Address: BLAKELY SOKOLOFF TAYLOR & ZAFMAN LLP, 1279 OAKMEAD PARKWAY, SUNNYVALE, CA, 94085-4040, US

(73) Assignees: QR LIMITED, Brisbane, Queensland (AU); AUSTRALIAN RAIL TRACK COPORATION LTD, Adelaide, South Australia (AU); PACIFIC NATIONAL (VICTORIA) LTD, Melbourne, Victoria (AU); ASCIANO SERVICES PTY LTD, Melbourne, Victoria (AU); TMG RAIL TECHNOLOGY PTY LTD, Sydney, New South Wales (AU); RAIL CORPORATION NSW, Sydney, New South Wales (AU); CENTRAL QUEENSLAND UNIVERSITY, North Rockhampton, Queensland (AU); UNIVERSITY OF WOLLONGONG, Wollongong, New South Wales (AU); MONASH UNIVERSITY, Monash University, Victoria (AU); UNIVERSITY OF SOUTH AUSTRALIA, Adelaide, South Australia (AU); QUEENSLAND UNIVERSITY OF TECHNOLOGY, Brisbane, Queensland (AU); THE UNIVERSITY OF QUEENSLAND, St Lucia, Queensland (AU)

(21) Appl. No.: 12/665,288

(22) PCT Filed: Jun. 19, 2008
(86) PCT No.: PCT/AU2008/000875

§ 371 Date: Jul. 13, 2010

(30) Foreign Application Priority Data
Jun. 19, 2007 (AU) 2007903276

(51) Int. Cl. B60B 19/00; C21D 9/34; C21D 1/62; C22C 38/00

(52) U.S. Cl. 295/30; 148/583; 266/259; 148/320

(57) ABSTRACT

A method of treating a steel railway wheels to form a required distribution of compressive residual stress in the rim. In general terms the wheel heated and then quenched from the plate towards the rim. The wheel is first heated to form austenite throughout the plate and rim portions. The wheel is then cooled to form bainite/martensite in the plate portion. The wheel is cooled to form bainite/martensite in an inner portion of the rim. The wheel is cooled to form bainite/martensite in an outer portion of the rim.

### FIELD OF THE INVENTION

This invention relates to heat treatment of steel railway wheels, and in particular but not only to treatment methods involving use of the martensite phase transition to produce a required distribution of residual stress in a wheel.

### BACKGROUND TO THE INVENTION

The running surface of a railway wheel (the tread) is subjected to an arduous environment of contact stresses and friction from contact with rails whilst supporting large axle loads. In many cases the tread of a railway wheel is also used as the brake drum of the train through brake shoes that are applied directly to the tread, consequently subjecting the tread to significant fluctuations in temperature and thermal stress.

All these inputs contribute to degradation of the tread which takes on forms of varying proportions of wear, rolling contact fatigue and thermal fatigue of the tread surface and material below the tread surface. Due to degradation of the tread, it is normally periodically refreshed by machining material from the surface to expose fresh undamaged material and restore the desired tread profile. Hence the outer part of the wheel, the rim on which the tread is the outer most surface is made sufficiently thick as to allow both sufficient structural support and additional material for refreshing via machining.

As the treads of wheels are subjected to cracking from fatigue, the wheel must have an inherent resistance to propagation of such cracks which in most railway wheels is provided by a combination of a material with sufficient toughness and a distribution of compressive residual stress (internal forces in the material) in the area most subject to cracking. In particular to resist cracking originating at and near the tread, the circumferential residual stresses should be compressive in the outer portion of the wheel rim. Heat treatment involving a tread quenching process such as shown in U.S. Pat. No. 5,899,516 is often used to achieve this distribution, for example.

The conventional processes for producing compressive residual stress in a steel wheel are suitable for wheels having a pearlitic microstructure, rather than bainitic, martensitic or mixed bainitic-martensitic microstructures. Conventional processes for heat treatment of railway wheels when applied to wheels having a martensitic microstructure generally produce a highly undesirable tensile residual stress in the outer portion of the rim. This is because pearlitic steels and bainitic/martensitic steels have very different characteristics when cooled from austenitic temperatures (>˜700- 950° C. depending on steel composition).

In this specification the term “bainitic/martensite” refers to steels which have bainitic, martensitic or mixed bainitic-martensitic microstructures

### SUMMARY OF THE INVENTION

It is therefore an object of the invention to provide an improved method for treating railway wheels, or at least to provide an alternative to existing methods.

In one aspect the invention may broadly be said to reside in a method of treating a steel railway wheel, including: (a) heating the wheel to form austenite throughout the plate and rim portions, (b) cooling to form bainite/martensite in an outer plate portion, (c) cooling to form bainite/martensite in an inner portion of the rim, and (d) cooling to form bainite/martensite in the outer portion of the rim.

Steps (a) to (d) are carried out sequentially to produce compressive residual stress in the outer rim portion. Preferably the outer plate portion is cooled by quenching for between 2 and 15 minutes, preferably between 5 and 10 minutes. Preferably the inner rim portion is cooled by quenching for between 2 and 15 minutes, preferably between 5 and 10 minutes.

Preferably the outer portion of the rim is cooled to room temperature or alternatively tempered for between 1 and 4 hours.

In another aspect the invention resides in a method of treating a steel railway wheel, including: (a) heating the wheel above the austenite transition temperature, (b) cooling an outer plate portion of the wheel below the martensite start temperature, (c) cooling an inner portion of the rim below martensite start temperature, and (d) cooling the outer portion of the rim to below the martensite start temperature.

In a further aspect the invention resides in a steel railway wheel which has been treated according to any of the preceding claims. The wheel preferably has a rim portion with a bainitic, martensitic or mixed bainitic-martensitic microstructure, with predominantly compressive circumferential stress in the outer portion of the rim.

The steel preferably has a composition in the range: 0.05-0.3% C, 3.00-5.00% Mn, 0.45-1.85% Si, (all % wt with no other alloying additions above 0.05% wt). A range of other compositions may also be suitable for wheels which are treated according to these methods.

The invention also resides in any alternative combination of features which are indicated in this specification. All equivalents of these features are deemed to be included.

### LIST OF FIGURES

Preferred embodiments of the invention will be described with respect to the accompanying drawings, of which:

FIG. 1 shows a typical railway wheel in cross section,

FIG. 2 is a simple phase-temperature diagram for steel,

FIG. 3 indicates a suitable distribution of stress in a. railway wheel,

FIG. 4 indicates how the distribution varies with depth from the tread,

FIG. 5 indicates cooling of the plate portion of the wheel,

FIG. 6 indicates cooling of the plate and rim portions of the wheel, and

FIG. 7 indicates typical quenching equipment.

### DESCRIPTION OF PREFERRED EMBODIMENTS

Referring to the diagrams it will be appreciated that the invention can be implemented in a range of different ways for a range of different wheels. The embodiments described here are given by way of example only.

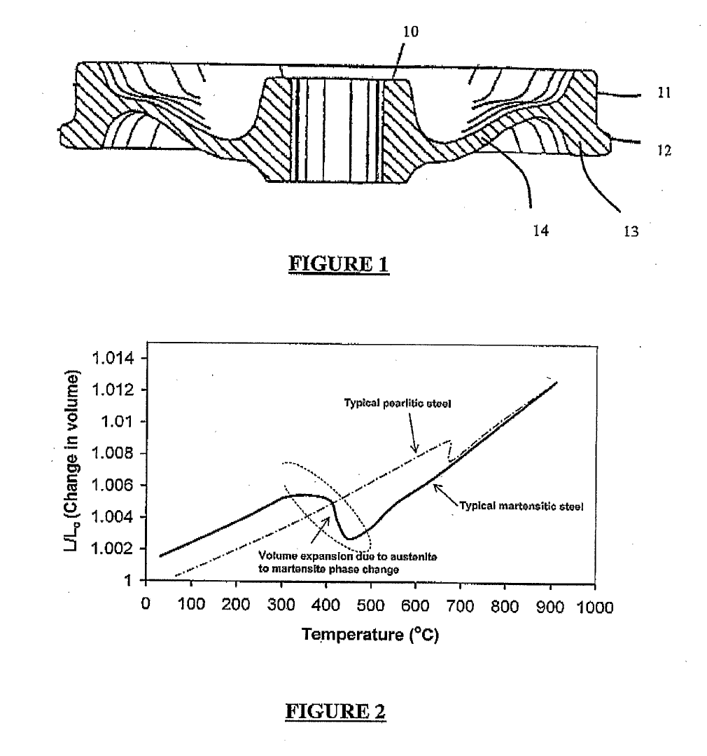

FIG. 1 shows the main portions of a steel railway wheel. Hub 10 supports an axle while tread 11 provides contact with a rail. Flange 12 prevents lateral movement on the rail. Rim 13 supports the tread and the flange while plate 14 connects the hub to the rim. A shape of this general kind has a number of variations in the railway industry around the world but is generally standard.

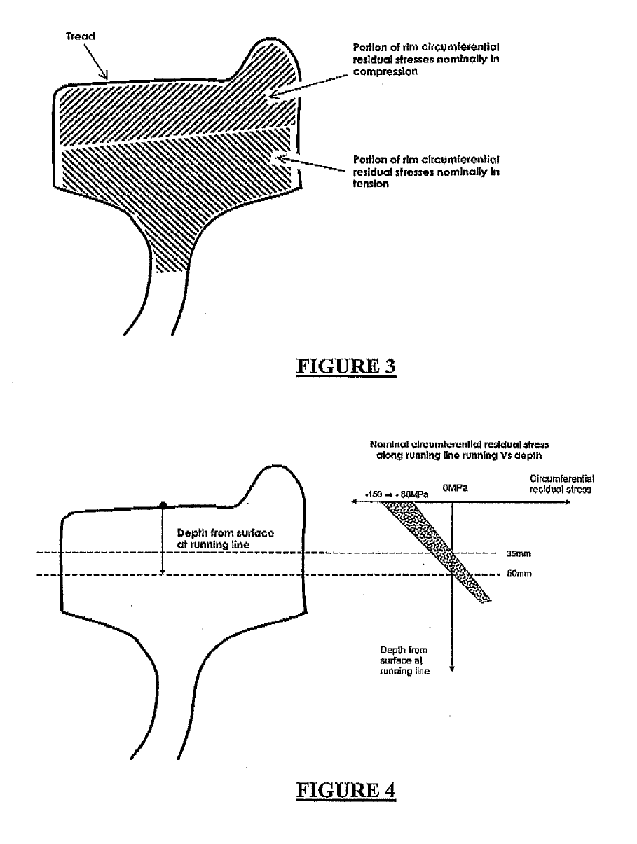

FIG. 2 schematically shows the dominant mechanism present during the cooling of steel from austenitic temperatures to a pearlitic microstructure, namely thermal contraction. It is this contraction of the steel that allows the formation of compressive residual stresses in the outer portion of the rim using the conventional procedure of quenching the wheel at the tread surface via a water spray quench. The stress is usually termed “circumferential” representing a predominant distribution of compressive stress around the circumference of the rim.

However, when bainitic/martensitic steels are cooled from austenitic temperatures the thermal contraction of the steel is accompanied with a large phase change expansion known as the martensite transition. This effect is caused by an atomic structural phase change from the face centre cubic metallic crystal structure of austenite to the body centred tetragonal structure of martensite. Known procedures of quenching a wheel made from martensitic/bainitic steel therefore tend to produce tensile stress in the tread. The martensitic transition typically takes place between 300 and 500° C., with the start (higher) temperature being typically 300 to 450° C., depending on the steel composition.

FIGS. 3 and 4 schematically show a desired distribution of stress in a steel railway wheel. The distribution is predominantly compressive in the outer portion of the rim and nominally tensile throughout an inner portion. The nature and location of the boundary region between these portions is approximate and depends on the particular wheel.

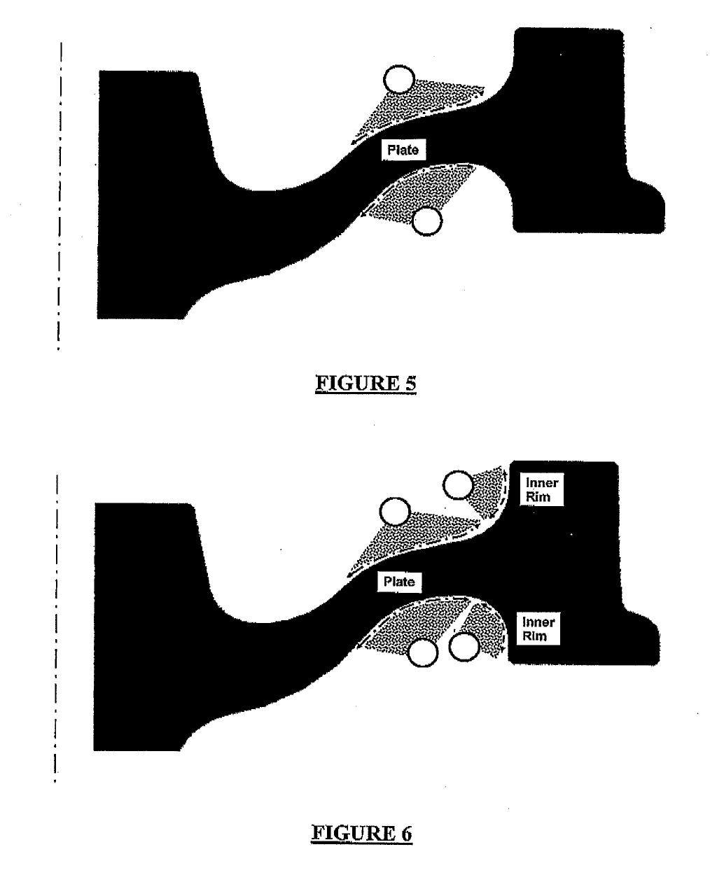

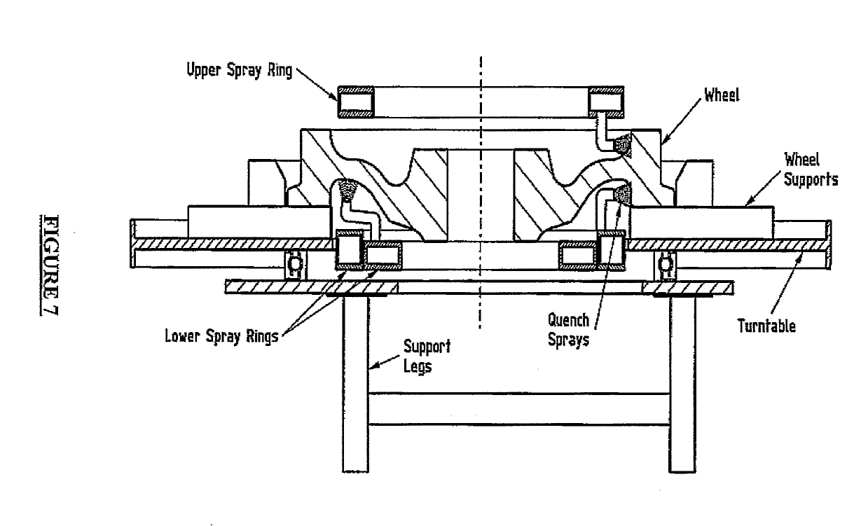

FIGS. 5 and 6 indicate how a distribution such as shown in FIGS. 3 and 4 may be achieved by heat treatment of a wheel having a bainitic/martensitic microstructure. Finite element computer modelling has shown that by using a procedure in which a sequence of quenches are applied to different parts of the wheel, compared to the conventional tread quench process, it is possible to produce the desired compressive residual stress distribution in the outer portion of the wheel.

The following procedure is applied to the wheel:
1. The wheel is heated in a furnace to a temperature in excess of the austenitising temperature (>˜700-950° C. depending on steel composition) and held at this temperature for a duration sufficient to achieve a fully austenitic structure throughout the steel.
2. The wheel is then transferred from the furnace to quenching apparatus. Apparatus of this kind is available in a range of different forms, with the wheel typically being held in a vertical or horizontal orientation, and with relative rotation between the wheel and the apparatus.
3. A quench of brine, water, oil, air or other suitable medium is applied to either or both sides of the outer part of the wheel plate, as shown in FIG. 5. This stage has a duration of between 2 and 15 minutes, and typically between 5 and 10 minutes depending on wheel size and geometry.
4. A quench of brine, water, oil, air or other suitable medium is then applied to either or both sides of the inner portion of the wheel rim, as shown in FIG. 6. Either or both sides of the outer part of the wheel plate are also preferably quenched. This stage has a duration of between 2 and 15 minutes, and typically of between 5 and 10 minutes depending on wheel size and geometry.
5. The wheel is removed from the quenching apparatus and allowed to either cool to room temperature or is subjected to a tempering/stress relieving heat treatment for duration of between 1 and 4 hours.
6. The wheel is then machined to final dimensions, ready for assembly in the normal way.

FIG. 7 shows typical quenching apparatus in more detail. A wheel is shown mounted in a horizontal orientation on a table, in relation to a quenching system having an array of spray nozzles. The nozzles arc actuated in a sequence as outlined above while the table rotates the wheel relative to the spray nozzles. A computer processor typically actuates the nozzles according to a program stored in electronic memory. Construction of the apparatus, such as the arrangement and actuation of the spray nozzles, can be provided in various ways.

The procedure described bore would be suitable for a range of bainitic, martensitic or mixed bainitic-martensitic steels, however it is intended typically for use with steels of the composition: 0.05-0.3% C, 3.00-5.00% Mn, 0.45-1.85% Si, (all % wt with no other alloying additions above 0.05% wt). Other compositions may also be suitable, such as those which substitute Cr or Mo for Mn, for example.

Such steels will produce bainitic-martensitic microstructures that have useful mechanical properties and could offer performance benefits to railway wheels in terms of being more durable and requiring less maintenance and improved safety. Typical mechanical properties of such steels are listed below.

Mechanical properties of wheel steels

| | | | | | | Room |
|---|---|---|---|---|---|---|
| | | | | | Dynamic | Temp |
| | Carbon | Microstructure | Hardness (HB) | | Fracture | Charpy |
| | content | (%, B = bainitic, | | Condemning | Toughness | V-notch |
| Steel Grade | (% wt) | M = Martensitic) | At surface | Limit | (MPa · m^{1/2}) | (J) |

Manganese Based Low Carbon Bainitic-Martensitic Steels

| | | | | | | |
|---|---|---|---|---|---|---|
| Steel L | 0.10 | 88B, 12M | 306 | 306 | 77.2 | 18.7 |
| Steel I | 0.15 | 33B, 67M | 374 | 374 | 74.7 | 35.0 |
| Steel H | 0.21 | 16B, 84M | 414 | 414 | 70.7 | 23.7 |

1. A method of treating a steel railway wheel, including:
(a) heating the wheel to form austenite throughout the plate and rim portions,
(b) cooling to form bainite/martensite in the plate portion,
(c) cooling to form bainite/martensite in an inner portion of the rim, and
(d) cooling to form bainite/martensite in an outer portion of the rim.

2. A method according to claim 1 wherein an outer part of the plate portion is cooled by quenching for between 2 and 15 minutes, preferably between 5 and 10 minutes.

3. A method according to claim 1 wherein the inner rim portion is cooled by quenching for between 2 and 15 minutes, preferably between 5 and 10 minutes.

4. A method according to claim 1 wherein the outer rim portion is cooled to room temperature or alternatively tempered for between 1 and 4 hours.

5. A method according to claim 1 wherein steps (a) to (d) are carried out sequentially to produce compressive residual stress in the outer rim portion.

6. A method according to claim 1 wherein the steal has a composition in the range: 0.05-0.3% C, 3.00-5.00% Mn, and 0.45-1.85% Si, (wherein all % wt with no other alloying additions are above 0.05% wt).

7. A method of treating a steel railway wheel, including:
(a) heating the wheel above the austenite transition temperature,
(b) cooling the plate portion of the wheel below the martensite start temperature,
(c) cooling an inner portion of the rim below the martensite start temperature, and
(d) cooling the outer portion of the rim to below the martensite start temperature.

8. Quenching apparatus for steel railway wheels which carries out a method according to claim 1.

9. A steel railway wheel which has been treated according claim 1.

10. A railway wheel having a rim formed from bainite/martensite steel in which an outer portion of the rim is under compressive circumferential stress.

11. A wheel according to claim 10 having a plate formed from bainite/martensite steel.
